(19) United States
(12) Patent Application Publication
(10) Pub. No.: US 2013/0054964 A1
(43) Pub. Date: Feb. 28, 2013

(54) METHODS AND APPARATUS FOR SOURCE AUTHENTICATION OF MESSAGES THAT ARE SECURED WITH A GROUP KEY

(71) Applicants: Thomas S. Messerges, Schaumburg, IL (US); Adam C. Lewis, Buffalo Grove, IL (US)

(72) Inventors: Thomas S. Messerges, Schaumburg, IL (US); Adam C. Lewis, Buffalo Grove, IL (US)

(73) Assignee: MOTOROLA SOLUTIONS, INC., Schaumburg, IL (US)

(21) Appl. No.: 13/216,487

(22) Filed: Aug. 24, 2011

(51) Int. Cl. H04L 9/32

(52) U.S. Cl. 713/163; 713/171

(57) ABSTRACT

Methods, systems and apparatus are provided for source authentication. In accordance with the disclosed embodiments, a key-management server generates a key-delivery message that includes a key data transport payload secured with a group key, and a source authentication payload. Upon receiving the key-delivery message at a communication device, the communication device may verify whether the source authentication payload of the key-delivery message is valid. When the source authentication payload is determined to be valid, the communication device thereby authenticates that the key-delivery message was transmitted by the key-management server.

### FIELD OF THE DISCLOSURE

The present disclosure relates generally to key-management protocols and more particularly to a method and apparatus for source authentication of messages that are secured with a group key.

### BACKGROUND

A key-management protocol relates to creation, distribution, and maintenance of a security key (also interchangeably referred to as a key) in a communication system. Different key-management protocols usually provide different sets of key-management operations and functionality.

Multimedia Internet KEYing (MIKEY) Protocol

Some communication systems support a Multimedia Internet KEYing (MIKEY) key management protocol that is intended for use with real-time applications. Any Request for Comments (RFC) documentation mentioned herein refers to documents that are maintained by the Internet Engineering Task Force (IETF). MIKEY is defined in RFC 3830 by Arkko, J., Carrara, E., Lindholm, F., Naslund, M., and K. Norrman, titled “MIKEY: Multimedia Internet KEYing,” August 2004. MIKEY can be used to set up traffic encryption keys for multimedia sessions that are secured using the Secure Real-time Transport Protocol (SRTP) that is described in RFC 3711. See, Baugher, M., McGrew, D., Naslund, M., Carrara, E., and K. Norrman, “The Secure Real-time Transport Protocol (SRTP),” RFC 3711, March 2004.

MIKEY supports three different modes of operation that can be used to set up a common secret to be used as, e.g., a session key or a session key encryption key (KEK). These modes of operation are known as pre-shared key (PSK) mode, public-key mode, and Diffie-Hellman mode. The pre-shared key mode and the public-key mode are both based on key-transport mechanisms, where the actual Traffic Encryption Key (TEK) or TEK Generation Key (TGK) is pushed (securely) to the recipient(s). In the Diffie-Hellman mode, the actual TGK is derived from the Diffie-Hellman values exchanged between the peers.

The pre-shared key (PSK) mode is the most efficient way to handle key transport since only symmetric cryptography and encryption is used, and only a small amount of data has to be exchanged. In the pre-shared key mode, a key-management server generates a TGK or TEK that is protected during transport using only a pre-shared key. This pre-shared key is shared between the initiator (e.g., a key server) and responder (e.g., a recipient). When transporting a key to a group of recipients, the key-transport message can be protected with a key shared between the initiator and all of the recipients in the group. However, when the pre-shared key is shared with more than one recipient in a group, a recipient cannot positively ascertain whether a key-transport message was secured by a legitimate key server or by a rogue recipient of the group that also possesses the pre-shared key. Thus, although MIKEY pre-shared key mode is often used for group communications, MIKEY pre-shared key mode does not allow or provide a mechanism for source authentication when a “pre-shared” key is used as the group key.

Multimedia Broadcast/Multicast Service (MBMS)

The 3rd Generation Partnership Project (3GPP) is developing standards that specify a multicast and broadcast service, known as the Multimedia Broadcast/Multicast Service (MBMS), and its security architecture. In general, the MBMS refers to a point-to-multipoint interface specification for existing and upcoming 3GPP cellular networks, which is designed to provide efficient delivery of broadcast and multicast services, both within a cell as well as within the core network. The security architecture for MBMS is specified in the document 3GPP TS 33.246, “Technical Specification 3rd Generation Partnership Project; Technical Specification Group Services and System Aspects; Security; Security of Multimedia Broadcast/Multicast Service.”

MBMS requires the use of the MIKEY Protocol [RFC3830] to convey the keys and related security policy needed to secure multimedia that is multicast or broadcast. MBMS uses MIKEY both as a registration protocol and a re-key protocol. The key-management solution adopted by MBMS uses three-level key management to distribute group keys to the clients, and to be able to re-key by pushing down a new group key. The types and identifies of keys that are involved in the MIKEY protocol in secure MBMS include an MBMS User Key (MUK), an MBMS Service Key (MSK), and an MBMS Traffic Key (MTK).

The MUK is a point-to-point key between the multicast server and each client. Here, a “client” refers to a communication device that has subscribed to a given multicast/broadcast service. The MUK is a first-level unique session key shared between the multicast server and the client that is derived from the client's unique key that was loaded a priori (i.e., it is not sent via MIKEY). The MUK is used as a pre-shared key to run MIKEY with the pre-shared key method [RFC3830], and to deliver (point-to-point) the MSK.

The MSK is a second-level group key (or key-encrypting key) that is shared between the multicast server and all the clients that belong to a particular group. The same MSK is pushed to all the clients in a particular group for use as a group key. Then, the MSK is used to push a third-level MTK to all the clients in the particular group. The MTK is an actual group traffic key that is used for the protection of the media traffic between the multicast server and all clients in a particular group. For example, the MTK could be the master key for the Secure Real-time Transport Protocol (SRTP) [RFC3711] in the streaming case. These traffic keys are the keys that are regularly updated.

Thus, in 3GPP's Secure MBMS (3GPP TS 33.246), MIKEY would support an MUK, an MSK and an MTK, where the MSK is delivered under the protection of the MUK and the MTK would be delivered under the protection of the MSK.

In the context of group communications, source authentication enables a group member to verify that a message received was indeed sent by a specific source (e.g., a specific member of the group). Traditionally, source authentication is achieved by having a sender digitally sign messages that it sends. Other techniques, such as the use of hash chains have also been proposed. See, for example, [RFC 4082], Perrig, A., Song, D., Canetti, R., Tygar, J., and B. Briscoe, “Timed Efficient Stream Loss-Tolerant Authentication (TESLA): Multicast Source Authentication Transform Introduction,” RFC 4082, June 2005; and [RFC4383] Baugher, M. and E. Carrara, “The Use of Timed Efficient Stream Loss-Tolerant Authentication (TESLA) in the Secure Real-time Transport Protocol (SRTP),” RFC 4383, February 2006.

Although secure MBMS added support for handling rekeys (i.e., multicasting a new traffic key protected with a group key-encrypting key), it does not provide a mechanism for source authentication. See, for example, Carrara, E., Lehtovirta, V., and K. Norrman, “The Key ID Information Type for the General Extension Payload in Multimedia Internet KEYing (MIKEY),” RFC 4563, June 2006.

Rather, in RFC 4563, the 3GPP indicates that: “ . . . the delivery of the MTK is not source origin authenticated, but rather protected by a group MAC, keyed by the group key (MSK). The threat this raises is that users that are part of the group are able to send fake MTK messages to other group members. The origin of the MTK messages is a node inside the core network, and the trust model used in MBMS is that only trusted traffic is allowed to be sent (from within the operator's network) on the MBMS bearers. However, there is always the risk that traffic is injected on the air interface between the base stations and the user equipment. It is possible for members of the group (i.e., with access to the MSK) to spoof MTK updates to other members of the group. The 3GPP decided that the technical difficulties and costs involved in performing such an attack are large enough compared to the expected gain for the attacker, that the risk was deemed acceptable.”

Accordingly, there is a need for a method and apparatus for source authentication of messages that are secured with a group key.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is block diagram of a communication system.

FIG. 2 illustrates a pre-shared key mode for key transport in accordance with a Multimedia Internet KEYing (MIKEY) standard.

FIG. 3 illustrates a data structure of a MIKEY key-delivery message transmitted by a key-management server in accordance with a pre-shared key mode of the MIKEY standard.

FIG. 4 illustrates a data structure of a MIKEY acknowledgement message transmitted by a communication device in accordance with a pre-shared key mode of the MIKEY standard.

FIG. 5 illustrates a modified pre-shared key MIKEY protocol that supports source authentication in accordance with some of the disclosed embodiments.

FIG. 6 illustrates a modified MIKEY key-delivery message of FIG. 5 in accordance with some of the disclosed embodiments.

FIG. 7 illustrates a modified MIKEY acknowledgement message of FIG. 5 in accordance with some of the disclosed embodiments.

FIG. 8 illustrates a digital signature method for generating a source authentication payload (SAP) and appending it to generate a modified MIKEY key-delivery message in accordance with some of the disclosed embodiments.

FIG. 9 illustrates a digital signature method for verifying the source authentication payload (SAP) in accordance with some of the disclosed embodiments.

FIG. 10 illustrates the concept of a hash chain that can be used in accordance with some of the disclosed embodiments.

FIG. 11 illustrates a method for generating a verification message payload (V_PAYLOAD) and appending it to generate a modified MIKEY acknowledgment message in accordance with some of the disclosed embodiments.

FIG. 12 illustrates a method for verifying a verification message payload (V_PAYLOAD) in accordance with some of the disclosed embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Methods, systems and apparatus are provided for source authentication. In accordance with some of the disclosed embodiments, a key-management server generates a key-delivery message comprising: a key data transport payload secured with a group key, and a source authentication payload. Upon receiving the key-delivery message at a communication device, the communication device may verify whether the source authentication payload of the key-delivery message is valid. When the source authentication payload is determined to be valid the communication device thereby authenticates that the key-delivery message was transmitted by the key-management server.

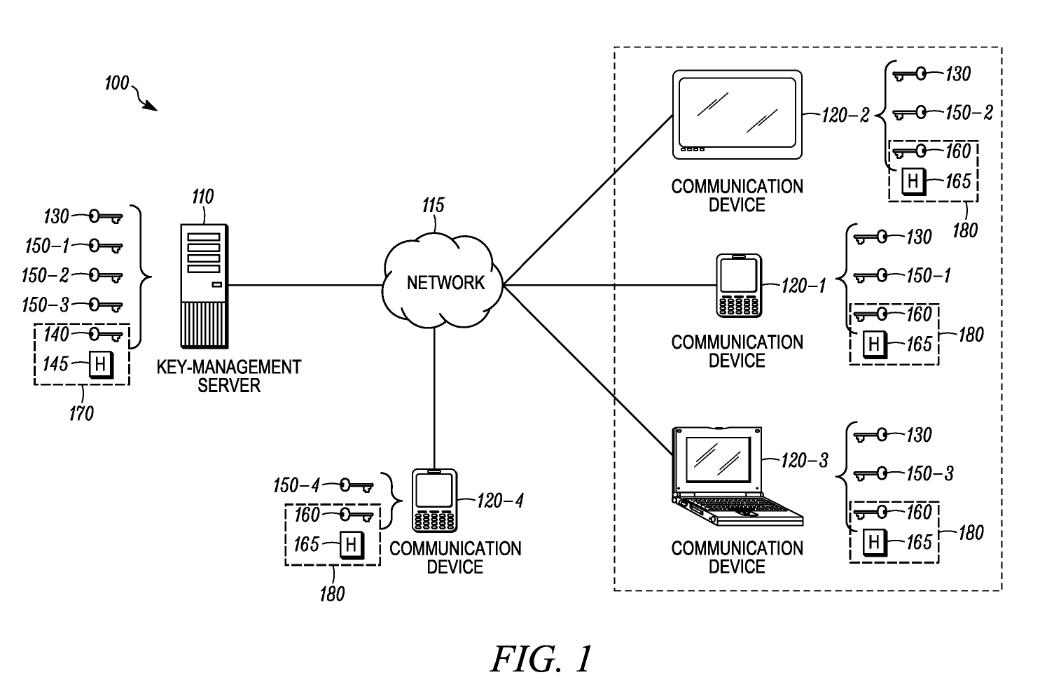

FIG. 1 is block diagram of a communication system 100. The network includes a server 110 and communication devices 120 that communicate with each other over a network 115. The server 110 and the communication devices can communicate with each other over the network 115 using either wired and/or connections, and although not illustrated, the network 115 may include numerous other infrastructure that is not illustrated. When described with reference to a key-management method of protocol, the server 110 may be referred to as a key-management server, and the communication devices 120 may be referred to as communication devices.

As used herein, the term “key-management server” refers to a server that is an initiator of a key-management protocol. In general, the key-management server 110 is an infrastructure device implemented within a communication system, such as a server, that facilitates secure key management and distribution. In some implementations, the key-management server may be called, for example, a Group Controller Key Server (GCKS) or a Key-Management Facility (KMF).

The term “communication device” refers to a communication device of a responder in the key-management protocol. The communication devices 120 can communicate over a wired and/or wireless communication link. Wired communication devices can be implemented using any general purpose computing device that can communicate over a wired network. Wireless communication devices can communicate over-the-air or wirelessly without need for a wired communication interface. Wireless communication devices are commonly referred to in the art as subscriber units, user equipment, access devices, access terminals, mobile stations, mobile subscriber units, mobile devices, user devices, and the like. In this regard, wireless communication devices 120 can be any type of communication device such as radios, mobile phones, mobile data terminals, Personal Digital Assistants (PDAs), laptops, two-way radios, cell phones, etc. The communication devices 120 can support the standard MIKEY protocols, and other legacy key-management protocols that may be, for example, TETRA or APCO-25 protocols. It should be observed that the TETRA and APCO-25 protocols support key-management functions, such as key deletion and update, which are not supported by the MIKEY protocol.

FIG. 1 also illustrates one non-limiting example of cryptographic keys and data that can be used in conjunction in accordance with the disclosed embodiments. These cryptographic keys include a pre-shared group key 130 and multiple pre-shared unique keys 150. In accordance with some of the disclosed embodiments the KMS 110 will also possess source authentication generation data 170, which may be, for example, a private key 140 or hash-chain root element 145, and communication devices 120-1 . . . 120-4 will possess source authentication verification data 180, which may be, for example, a public key 160 (corresponding to private key 140) or hash-chain last element 165.

The KMS 110 and communication devices 120-1 . . . 120-3 share a pre-shared group key (e.g., MSK) 130 since they are members of a communication group. The communication device 120-4 does not belong to the communication group and therefore does not have a pre-shared group key 130. Each communication device 120-1 . . . 120-4 and the KMS 110 have a pre-shared unique key 150. As illustrated, there are four pre-shared unique keys: a pre-shared unique key 150-1, a pre-shared unique key 150-2, a pre-shared unique key 150-3 and a pre-shared unique key 150-4. The communication device 120-1 has a pre-shared unique key 150-1, the communication device 120-2 has a pre-shared unique key 150-2, the communication device 120-3 has a pre-shared unique key 150-3, and the communication device 120-4 has a pre-shared unique key 150-4.

Thus, in one example, the KMS 110 will have six keys that include a pre-shared group key 130, private key 140, a pre-shared unique key 150-1, a pre-shared unique key 150-2, a pre-shared unique key 150-3, a pre-shared unique key 150-4, the communication device 120-1 will have three keys that include a pre-shared group key 130, a pre-shared unique key 150-1, and a public key 160, the communication device 120-2 will have three keys that include a pre-shared group key 130, pre-shared unique key 150-2, and public key 160, the communication device 120-3 will have three keys labeled pre-shared group key 130, pre-shared unique key 150-3, and public key 160, and the communication device 120-4 will have at least two keys labeled pre-shared unique key 150-4 and public key 160, but will not have a pre-shared group key 130 because it is not a group member. In another example, the private key 140 in the KMS 110 would be replaced with hash-chain root element 145 and public key 160 in communication devices 120-1 . . . 120-4 would be replaced with hash-chain last element 165. Use of the various cryptographic keys and hash-chain elements in accordance with the disclosed embodiments will be described below.

In general, the key-management server 110 and communication devices 120 of system 100 are implemented using one or more (although not shown) memory devices, network interfaces, and processing devices that are operatively coupled, and which when programmed form the means for these system elements to implement their desired functionality.

The network interfaces are used for signaling or messaging (e.g., packets, datagrams, frames, superframes, or any other information blocks) between the key-management server 110 and the communication devices 120 of the system 100. The implementation of the network interfaces depends on whether the connection between the elements is wired or wireless. For example, the interfaces between two elements within system 100 can include one or more wired interfaces such as a serial port interface (e.g., compliant with the RS-232 standard), a parallel port interface, an Ethernet interface, a USB interface, and/or a FireWire interface, and the like. Where the interfaces support communications, the interfaces comprise elements including processing, modulating, and transceiver elements that are operable in accordance with any one or more standard or proprietary interfaces, wherein some of the functionality of the processing, modulating, and transceiver elements may be performed by means of the processing device through programmed logic such as software applications or firmware stored on the memory device of the system element or through hardware.

The processing device utilized by the elements of system 100 may be programmed with software or firmware logic or code for performing functionality described by reference to the figures below; and/or the processing device may be implemented in hardware, for example, as a state machine or ASIC (application specific integrated circuit). The memory implemented by these system elements can include short-term and/or long-term storage of information needed for the functioning of the respective elements. The memory may further store software or firmware for programming the processing device with the logic or code needed to perform its functionality.

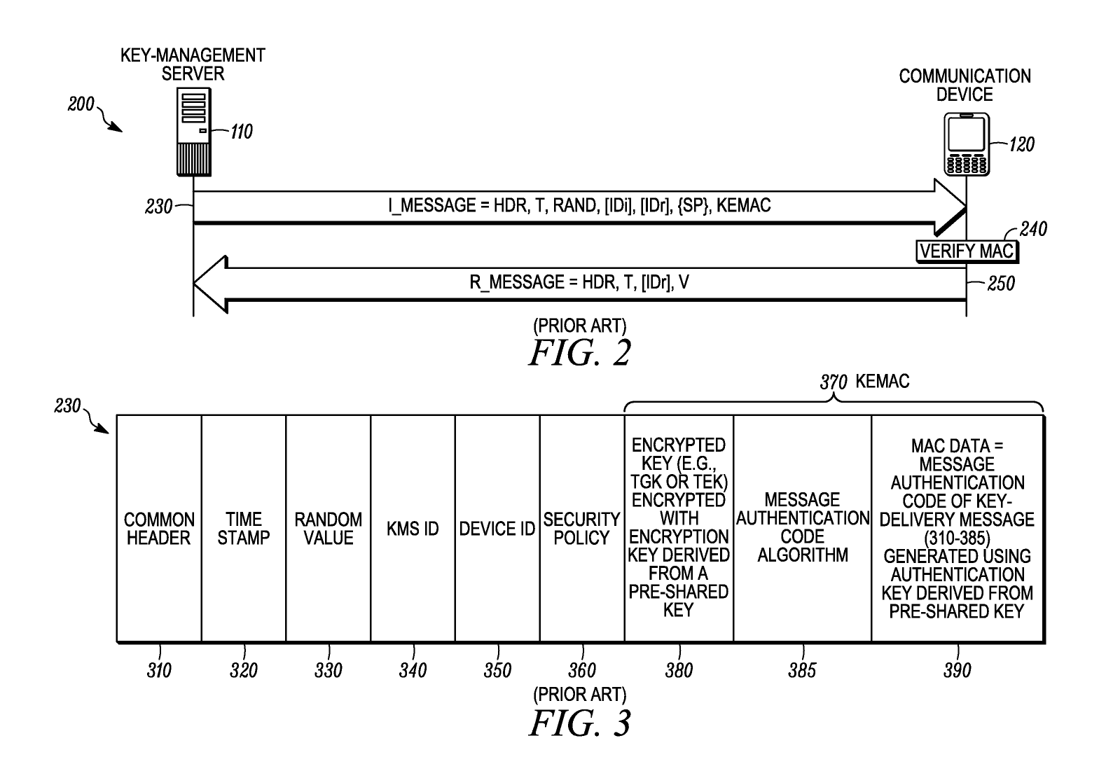

FIG. 2 illustrates the standard MIKEY pre-shared key protocol 200, a pre-shared key mode for key transport in accordance with a Multimedia Internet KEYing (MIKEY) standard.

In this method, a pre-shared key is used as one of the inputs into a function that is used to derive key material for both the encryption (encr_key) and the integrity protection (auth_key) of the MIKEY messages, as described in Section 4.1.4 of RFC 3830. The encryption and authentication transforms are described in Section 4.2 of RFC 3830.

As illustrated in FIG. 2, the key-management server 110 transmits a MIKEY key-delivery message 230. FIG. 3 illustrates a data structure of an MIKEY key-delivery message 230 transmitted by a key-management server 110 in accordance with a pre-shared key mode of the Multimedia Internet KEYing (MIKEY) standard. The main objective of the MIKEY key-delivery message 230 (I_MESSAGE) is to transport one or more TEKs or TGKs (carried in the encrypted key data sub-payload 380 of key data transport payload (KEMAC) 370) and a set of security policies (SPs) 360 to the communication device 120 in a secure manner. As illustrated in FIG. 3, the MIKEY key-delivery message 230 includes a common header (HDR) payload 310, a timestamp (T) payload 320, a random (RAND) value payload 330, a key-management server ID [IDi] payload 340, a communication device identifier [IDr] payload 350, a security policy payload {SP} 360 that includes zero or more security policies, and a key data transport payload (KEMAC) payload 370.

The common header (HDR) payload 310 is a general MIKEY common header, which includes MIKEY Crypto Session Bundle (CSB) related data (e.g., CSB ID) and information mapping to the specific security protocol used. See Section 6.1 of RFC 3830 for payload definition. As the verification message payload (V_PAYLOAD) from the communication device 120 is optional, the key-management server 110 can indicate in the HDR payload 310 whether or it requires a verification message payload (V_PAYLOAD) from the communication device 120.

The timestamp (T) payload 320 is used mainly to prevent replay attacks. See Section 6.6 of RFC 3830 for payload definition and also Section 5.4 of RFC 3830 for other timestamp related information.

The random (RAND) value payload 330 includes a random/pseudo-random byte-string, which is always included in the first message from the key-management server. RAND is used as a freshness value for the key generation. It is not included in update messages of a CSB. See Section 6.11 of RFC 3830 for payload definition.

The key-management server ID [IDi] payload 340 includes an identifier (ID) for the key-management server 110, whereas the communication device identifier payload [IDr] 350 includes an identifier (ID) for the communication device 120. See Section 6.7 of RFC 3830 for payload definition.

The security policy {SP} payload 360 specifies the security policies for the data security protocol. See Section 6.10 of RFC 3830 for payload definition.

The key data transport payload (KEMAC) payload 370 includes an encrypted key data sub-payload 380 concatenated with a Message Authentication Code Algorithm sub-payload 385 and a Message Authentication Code data sub-payload 390, which can be represented as:

KEMAC=E(encr_key, {TGK})∥MAC

where the notation E(encr_key, {TGK}) represents encryption of one or more TGKs (or TEKs) with the an encryption key (encr_key), and the notation ∥ means concatenation. The encrypted key data sub-payload 380 is encrypted with an encryption key derived from a pre-shared key, and the Message Authentication Code (MAC) data sub-payload 390 is generated using the MAC algorithm defined in sub-payload 385 along with a key derived from the same pre-shared key.

The KEMAC payload contains a set of encrypted sub-payloads 380 and a MAC algorithm and data sub-fields 385, 390. Each KEMAC payload includes a TGK or TEK chosen by the key-management server 110 (and other possible related parameters, e.g., the key lifetime). In other words, the encrypted key data sub-payload 380 includes at least one TGK or TEK that has been encrypted with a key derived from a pre-shared key. A TGK is used by the communication device 120 to generate Traffic-Encrypting Keys (TEKs) without needing further communication with the key-management server 110. In other words, the TEKs are derived from a crypto session bundle (CSB)'s TEK Generation Key (TGK). As used herein, a “Traffic-Encrypting Key (TEK)” refers to a key used by a security protocol to protect the crypto session (CS) (this key may be used directly by the security protocol or may be used to derive further keys depending on the security protocol). For example, the TEK could be the master key for a CS based on the SRTP [RFC3711]. As used herein, the term “TGK re-keying” refers to the process of re-negotiating/updating the TGK (and consequently future TEK(s)).

The Message Authentication Code (MAC) data sub-payload 390 is a Message Authentication Code covering the entire MIKEY message using the authentication key (auth_key). See Section 6.2 of RFC 3830 for payload definition and Section 5.2 of RFC 3830 for an exact definition of the MAC calculation.

As illustrated in FIG. 2 at 240, the communication device 120 verifies the Message Authentication Code (MAC) that is included in the MIKEY key-delivery message 230.

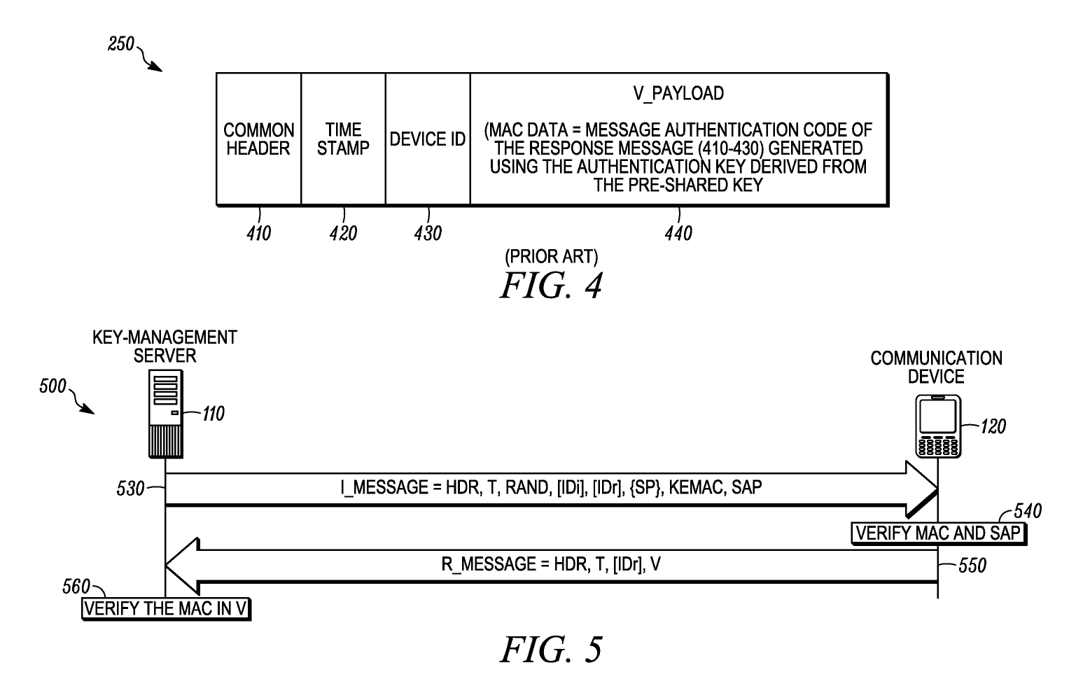

The communication device 120 then generates and transmits a MIKEY acknowledgement message 250 back to the key-management server. FIG. 4 illustrates a data structure of a MIKEY acknowledgement message 250 transmitted by a communication device 120 in accordance with a pre-shared key mode of the Multimedia Internet KEYing (MIKEY) standard. The MIKEY acknowledgement message 250 includes: a common header payload 410, a timestamp payload 420, a communication device identifier payload [IDr] 430, and a verification message payload (V_PAYLOAD) 440. The verification message payload (V_PAYLOAD) 440 contains Message Authentication Code data. The Message Authentication Code data is generated using an authentication key derived from the same pre-shared key. The main objective of the verification message payload (V_PAYLOAD) 440 from the communication device 120 is to obtain mutual authentication (i.e., the key-management server can authenticate that key-management message 230 was successfully received by the intended recipient). In the case of a single recipient, this authentication is exact. That is, the key-management server can cryptographically ascertain exactly which device acknowledged receipt of key-management message 230 (since presumably no other device also shares the pre-shared key needed to secure the acknowledgement message 250). However, in the case of a group of recipients, this authentication is imprecise. There is no way to cryptographically ascertain which recipient is acknowledging the message, since all recipients in the group have knowledge of the pre-shared key. Hence, source authentication of acknowledgement message 250 is not achieved.

The verification message payload (V_PAYLOAD) 440 is a MAC computed over the common header 410, the time stamp 420 (the same as the one that was included in the key-management server's message 230), and the communication device identifier 430 of the acknowledgement message 250, using the authentication key. See also Section 5.2 for the exact definition of the Verification MAC calculation and Section 6.9 for payload definition.

Thus, as shown in FIGS. 2-4, security of the MIKEY key-delivery message 230 and the MIKEY acknowledgement message 250 is based on a single pre-shared key.

Drawbacks of the MIKEY Pre-Shared Key (PSK) Protocol

When MIKEY is in implemented in some communication networks, certain group key-management messages can be sent out by anyone in a group. However, because they are protected solely by a group key, these messages may be vulnerable to some types of security attacks. Examples of vulnerable group key-management messages are all those that are sent to a group under the protection of a group key. Examples would include load/modify key messages, update key messages, delete key messages, activate key messages, etc. A very specific example would be an MTK rekey message protected by the group's MSK.

A rogue group member could potentially inject a spoofed key-management message into the network that appears to be legitimate to other group members. Such rogue messages could cause unsuspecting group members to accept illegitimate keys—resulting in a denial-of-service attack, or force the use of a weak key that is known and controlled by the attacker. Therefore, in these types of networks, the risk of rogue group members and spoofed key-management messages is increased. Accordingly, techniques are needed for protecting against spoofed key-management messages.

The MIKEY PSK Protocol Lacks Source Authentication Methods

The original MIKEY standard (RFC 3820) does not address source authentication of MIKEY messages, such as key-management messages (e.g., authenticating rekey messages). As such, in many such systems that implement (or that will eventually implement) a MIKEY protocol, there is no method for source authentication.

Simply ignoring the need for source authentication is not an option in some types of networks. For example, some newer public-safety radio communication systems that are being developed for use by the public-safety market, will use MIKEY's pre-shared key mode for key transport. The user equipment in these networks may be based on standard mobile computers or PDAs and may operate on public broadband networks (e.g., an LTE network) rather than private narrowband networks. Rouge group members may be present on these networks, especially on public networks not under the direct control of a public-safety agency, Therefore, without extra precautions, user equipment on these systems may not be able to avoid spoofing messages from rouge group members.

Although some high-level solutions exist in general for source authentication, no solution has been proposed for MIKEY key-management messages. There is a need for source authentication in the context of the pre-shared key MIKEY protocol (or MIKEY pre-shared key mode).

It would be desirable to provide methods and apparatus that implement protocols that can give communication devices (e.g., user equipment (UE)) the ability affirm or confirm that a key-management server (e.g., Group Controller and Key Server (GCKS)) is the true source of key-management messages, and vice-versa. It would also be desirable to provide a method and apparatus for source authentication in MIKEY pre-shared key mode when a group key is used as the “pre-shared key.” Accordingly, there is a need for a method and apparatus for source authenticating MIKEY messages that extend the standard MIKEY protocol to support source authentication operations.

Modified MIKEY Protocol that Provides Source Authentication

In accordance with the disclosed embodiments, a modified MIKEY protocol will be described. The modified MIKEY protocol implements modified key-delivery and acknowledgment messages. The modified MIKEY protocol, along with the modified key-delivery message generated by a KMS 110 and the modified acknowledgment message generated by a communication device 120 will be described below with reference to FIGS. 5, 6, and 7. Various options that are possible with these modified MIKEY messages will also be described. The modified MIKEY protocol is designed so that a communication device 120 can determine that the KMS 110 is the source of the modified key-delivery message and that the KMS 110 can determine which particular communication device 120 is the source of the modified acknowledgment message. This ability for source authentication prevents rouge communication devices from injecting false key-delivery or acknowledgement messages into the network or system that might otherwise be mistakenly accepted as being legitimate.

FIG. 5 illustrates the modified Multimedia Internet KEYing (MIKEY) protocol 500 that supports source authentication in accordance with some of the disclosed embodiments. The modified MIKEY protocol 500 adds source authentication capabilities to the pre-shared key MIKEY protocol that is described above with reference to FIGS. 2-4.

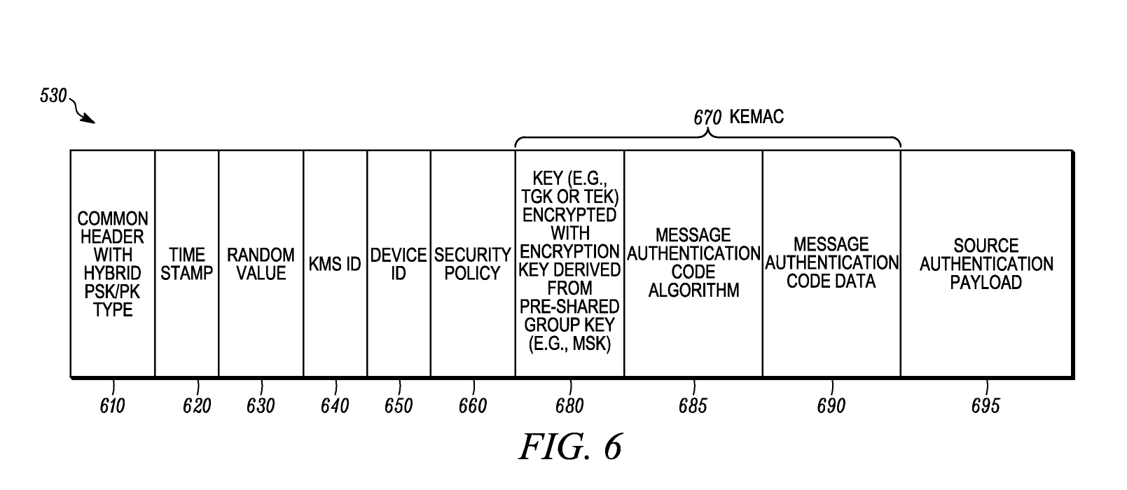

As illustrated in FIG. 5, the key-management server 110 generates and transmits a key-delivery message 530, where key-delivery message 530 is a modified version of the standard MIKEY key-delivery message 230. FIG. 6 illustrates a data structure of a key-delivery message 530 transmitted by the key-management server 110 in accordance with the modified MIKEY protocol 500 in accordance with some of the disclosed embodiments. The main objective of the key-delivery message 530 (also referred to as an I_MESSAGE in the MIKEY standard) is to transport one or more TGKs or TEKs (carried in the encrypted key payload 680 of a key data transport payload (KEMAC) 670), and a set of security policies (SPs) 660 to the communication device 120 in a secure manner such that communication device 120 can authenticate the source of the message. A secondary objective of the key-delivery message 530 is to transport source authentication verification data 180 (e.g., carried in the KMS ID payload 640, or other a new payload) to the communication device 120 in a secure manner such that communication device 120 can authenticate the source of the message.

As illustrated in FIG. 6, the key-delivery message 530 includes a common header (HDR) payload 610, a timestamp (T) payload 620, a random (RAND) value payload 630, an optional key-management server ID [IDi] payload 640, an optional communication device identifier [IDr] payload 650, a security policy payload {SP} 660 that includes zero or more security policies, the key data transport payload (KEMAC) payload 670, and a source authentication payload 695. The payloads 620, 630, 650, and 660 are identical to those described above with respect to FIG. 3. In some embodiments, the header payload 610, KMS ID payload 640, and the KEMAC payload 670 may be identical to common header payload 310, KMS ID payload 340, and KEMAC payload 370, that are described above with respect to FIG. 3, respectively.

In accordance with some of the disclosed embodiments, the common header (HDR) payload 610 can be modified to include a message type that indicates that the key-delivery message 530 is to be processed per a modified MIKEY protocol. It is noted that in any of disclosed embodiments that the modification of the common header payload is optional. In one implementation, the common header (HDR) payload 610 has a data type PSK+SIGNi, which means that it is a hybrid pre-shared key/public key MIKEY key-delivery message 530. In one implementation, the data type PSK+SIGNi has a value in the range of 26 to 240 that is not defined in any of the prior MIKEY standards.

In accordance with some of the disclosed embodiments, the KMS ID payload 640 can be modified to include source authentication verification data 180. Alternatively, a new payload may be defined to transport source authentication verification data 180. It is noted that in any of disclosed embodiments that the inclusion of the KMS ID payload 640 in key-delivery message 530 is optional. Also, when the KMS ID payload 640 is included, modification of the KMS ID payload 640 to transport source authentication verification data 180 is optional. That is, not all key-delivery messages 530 must transport source authentication verification data 180.

The key data transport payload (KEMAC) 670 comprises an encrypted key data sub-payload 680, a Message Authentication Code Algorithm sub-payload 685, and a Message Authentication Code data sub-payload 690.

In one embodiment, the encrypted key data sub-payload 680 contains a Traffic-encrypting key (TEK) or a Traffic-encrypting key Generation Key (TGK), where the TEK or TGK data is encrypted with a key derived from a pre-shared group key 130 (e.g., MSK). The encrypted key data sub-payload 680 includes at least one TGK (or TEK) that can be randomly and independently chosen by the key-management server 110. The TGK (or TEK) can be encrypted with an encryption key (encr_key) derived from a pre-shared group key 130 (e.g., MSK in one implementation). The pre-shared group key 130 is a group key (or key-encrypting key) that is shared between the key-management server 110 and all the communication devices 120 in a group. The same pre-shared group key 130 is pushed to all the communication devices 120 in the group, to be used as a second-level group key. Thus, the key data sub-payloads 680 of the key data transport payload (KEMAC) payload 670 is/are encrypted with the encryption key (encr_key) derived from the pre-shared group key 130 (e.g., MSK in one implementation). In another embodiment, the encrypted key data sub-payload 680 may be empty, such as when key-delivery message 530 is used to transport source authentication verification data 180, rather than a TGK or TEK.

The Message Authentication Code (MAC) Algorithm sub-payload 685 may include any known MAC algorithm, and the Message Authentication Code data sub-payload 690 includes MAC data. For example, in accordance with one implementation, the Message Authentication Code Algorithm sub-payload 685 specifies a Message Authentication Code Algorithm that is used in conjunction with an authentication key (derived from the pre-shared group key 130), and the encrypted key data sub-payload 680 to compute the Message Authentication Code data that populates the Message Authentication Code data sub-payload 690. In other words, the Message Authentication Code data sub-payload 690 is generated using an authentication key derived from the pre-shared group key 130. In one implementation, the Message Authentication Code data sub-payload 690 comprises Message Authentication Code Data that is computed only over the encrypted key data sub-payload 680 and the Message Authentication Code Algorithm 685. In another implementation, the Message Authentication Code data sub-payload 690 comprises Message Authentication Code Data that is computed only over all payloads of the key delivery message 530, except Message Authentication Code data sub-payload 690. In another implementation, the Message Authentication Code data sub-payload 690 comprises Message Authentication Code Data that is computed only over all payloads of the key delivery message 530, except the source authentication payload 695 and Message Authentication Code data sub-payload 690. Inclusion of the MAC sub-payloads 685 and 690 protects the integrity of the payloads for which the MAC is computed over. Entities not in possession of the pre-shared group key 130 are prevented from undetectably modifying any of the MAC-protected payloads.

Alternatively, in some implementations, the MAC Algorithm sub-payload 685 may be set to null, in which case the MAC data sub-payload 690 is left empty. In these implementations, it may be the case that the MAC data is not needed because the source authentication payload 695 is also included.

Also, in some implementations, the key data transport payload (KEMAC) 670 can be eliminated altogether, for example, when activating or deleting a previously delivered key as described, for example, in U.S. patent application Ser. No. 12/961,992, filed Dec. 7, 2010, entitled “METHOD AND APPARATUS FOR EXTENDING A KEY-MANAGEMENT PROTOCOL,” and assigned to the assignee of the present invention, which is incorporated herein by reference in its entirety. U.S. patent application Ser. No. 12/961,992 describes ways to extend MIKEY to support key deletion and activation.

In accordance with the disclosed embodiments, the source authentication payload 695 is included in the key-delivery message 530 transmitted by the key-management server 110. The source authentication payload 695 is generated based on source authentication generation data 170 that is known by the key-management server 110, but not known by any other members of the communication group, such as communication devices 120-1 . . . 120-4. The authenticity of the source authentication payload 695 can be verified by any communication device 120 in the group by using the corresponding source authentication verification data 180. The use of source authentication generation data 170 to generate the source authentication payload 695 provides proof to communication device 120 that key-delivery message 530 truly originated from key-management server 110. That is, since no communication device 120 in the group possesses source authentication generation data 170, no other device could have generated a valid source authentication payload 695.

Referring again to FIG. 5, when the communication device 120 receives the key-delivery message 530, the communication device 120 reads the common header (HDR) payload 610, which provides the communication device with information needed to determine how to parse and process the key-delivery message 530.

At block 540, the communication device 120 verifies the MAC data 690 (if present) and the source authentication payload 695 (if present) in the key-delivery message 530. When the source authentication payload 695 has been verified to be valid, communication device 120 determines that the key-delivery message 530 originated from the key-management server 110. This allows the communication device 120 to verify or “authenticate” that the key-delivery message 530 originated from the key-management server 110. By contrast, when the source authentication payload 695 is checked and determined to be invalid, the communication device 120 determines that it cannot confirm that the key-delivery message 530 originated from the key-management server 110. The communication device 120 can then discard the key-delivery message.

As illustrated in FIG. 5, after verifying the Message Authentication Code data sub-payload 690 and SAP at 540, the communication device 120 then generates and transmits an acknowledgement message 550 back to the key-management server 110, where acknowledgement message 550 is a modified version of MIKEY acknowledgement message 250.

In one embodiment, the acknowledgement message 550 can be identical to that described above with reference to FIGS. 2 and 4.

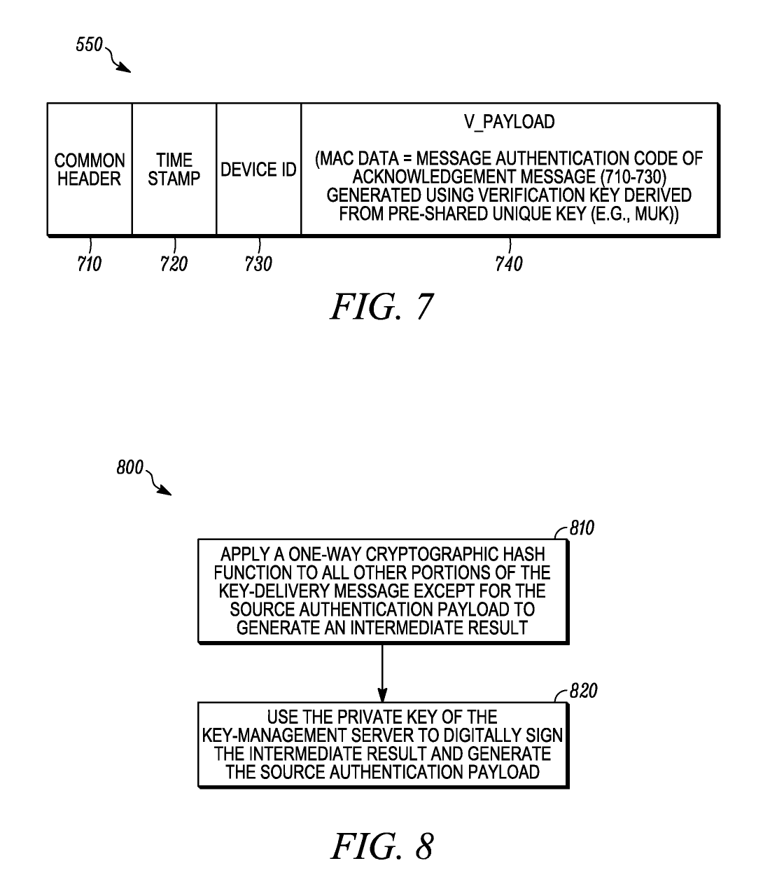

In other disclosed embodiments, FIG. 7 illustrates a data structure of an acknowledgement message 550 transmitted by the communication device 120. Like the MIKEY acknowledgement message 250 of FIG. 4, the acknowledgement message 550 includes: a common header payload 710, a time stamp payload 720, an optional communication device identifier payload [IDr] 730, and a verification message payload (V PAYLOAD) 740 that includes Message Authentication Code data within the MIKEY-defined V payload. The Message Authentication Code data within the verification message payload 740 (V_PAYLOAD) is generated using a verification key derived from a pre-shared unique key 150 that is shared between only the key-management server 110 and the communication device 120. Since no other device (other than the key-management server 110) should have this verification key, no other device can generate the correct MAC. So the ability to generate a correct MAC by any device not possessing pre-shared unique key 150 is prevented. For example, in one implementation, this verification key can be a key derived from MUK. As such, a distinct pre-shared unique key 150 (that only the communication device 120 and the key-management server 110 possess) is used to protect the acknowledgement message 550. This use of this pre-shared unique key 150 allows the key-management server 110 to source authenticate the acknowledgement message 550 from the communication device 120 without requiring the communication device 120 to conduct a costly public-key (asymmetric-key) operation.

In the above embodiment, one way that the modified MIKEY protocol 500 differs from the standard MIKEY pre-shared key protocol 200 is in the types of keys used to protect the key delivery and acknowledgment messages. In the standard MIKEY pre-shared key protocol 200, key-delivery message 230 is protected with the same key as acknowledgment message 240 (i.e., the pre-shared key). However, in the modified MIKEY protocol 500, the key-delivery message 530 is protected with a pre-shared “group” key while the acknowledgment message 550 is protected with a pre-shared “unique” key. The use of two distinct keys in the modified MIKEY protocol 500 provides for secure delivery of a TEK or TGK, while also enabling source authentication of the acknowledgment message 550. Furthermore, the addition of the source authentication payload 695 enables source authentication of the key-delivery message 530.

Source Authentication Using Digital Signature Method

In accordance with one embodiment, referred to herein as the “digital signature method,” the source authentication payload 695 is comprised of a signature payload representing a digital signature of the key-delivery message 530 transmitted by the key-management server 110. The source authentication generation data 170 will comprise the private key 140 and the source authentication verification data 180 will comprise the public key 160. The signature payload is not included in the standard MIKEY pre-shared key protocol 200 (e.g., a protocol that relies on symmetric-key cryptography), but is specified in other MIKEY modes (e.g., MIKEY public-key and Diffie-Hellman protocols) that rely on asymmetric-key cryptography.

The signature payload comprises a digital signature of the key-delivery message 530 that is generated using a private key 140 of the key-management server 110. The private key 140 is kept only in the key-management server 110 and is never shared. The communication device 120 only gets the public key 160 that corresponds to this private key 140. Because the signature payload is used for source authentication payload 695, the MAC sub-payload 390 of the key-delivery message 330 that is normally transmitted by the key-management server 110 is no longer needed, and a “NULL” authentication method can be used in some implementations.

FIG. 8 illustrates a method 800 for generating source authentication payload 695 and appending it to generate the key-delivery message 530 in accordance with some of the disclosed embodiments for when the digital signature method is used. Method 800 begins at 810, where key-management server 110 applies a one-way cryptographic hash function to all portions 610-690 of the key-delivery message 530 except for the source authentication payload 695 to generate an intermediate result, and then proceeds to 820, where the key-management server 110 uses its private key 140 to digitally sign the intermediate result and generate a signature payload that is used for source authentication payload 695. The MIKEY specification mentions two possible signature algorithms that can be used, RSA/PKCS#1/1.5 or RSASSA-PSS signature (both described in PKCS #1 v2.1—RSA Cryptography Standard, RSA Laboratories, Jun. 14, 2002), however other appropriate signature schemes known in the art, could be used.

Thus, the key-delivery message 530 that is described above for the digital signature method differs from the standard MIKEY pre-shared key protocol 200 in that a private key 140 of the key-management server 110 is used to digitally sign the key-delivery message 530. The private key 140 used to create source authentication payload 695 is known to key-management server 110 and the communication device 120 has the public key 160 corresponding this private key 140. The private key 140 of the key-management server 110 is used to generate a digital signature that is carried in the source authentication payload 695. The public key 160 is used to by the communication device 120 to verify the digital signature in the source authentication payload 695.

Referring again to FIG. 5, when the communication device 120 receives the key-delivery message 530, the communication device 120 reads the common header (HDR) payload 610, which provides the communication device 120 with information needed to determine how to parse and process the key-delivery message 530.

At block 540, in the digital signature method, the communication device 120 uses a public key 160 (that is paired with the private key 140 of the key-management server 110) to verify the digital signature in the source authentication payload 695 in the key-delivery message 530. This allows the communication device 120 to verify or “authenticate” that the key-delivery message 530 originated from the key-management server 110. Methods for delivering the public key 160 that are used to verify the digital signature will be described below.

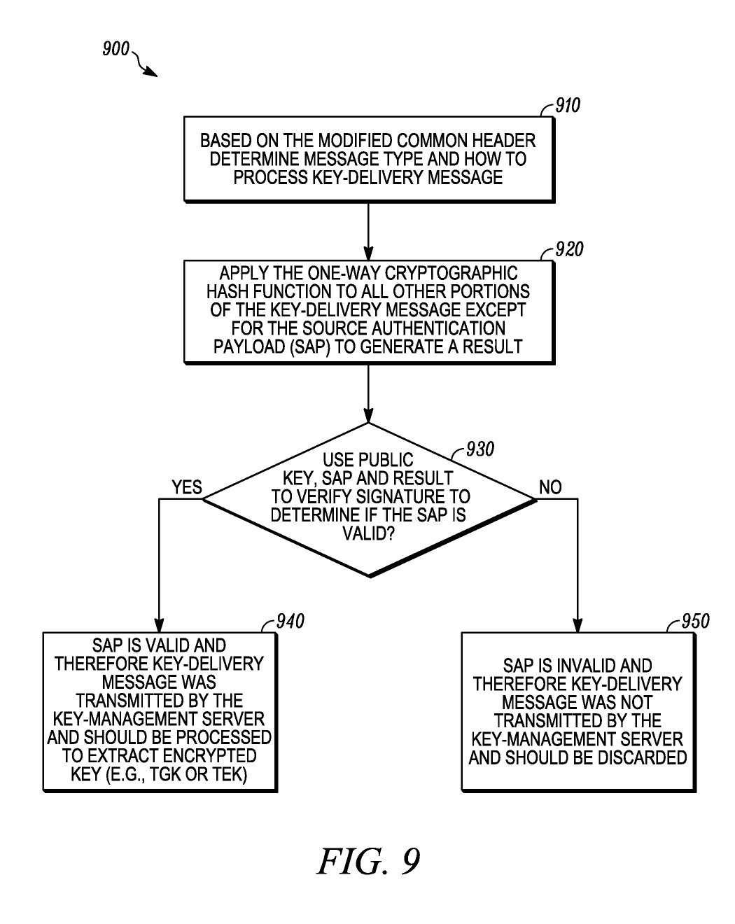

FIG. 9 illustrates a method 900 for verifying the digital signature of the source authentication payload 695 in accordance with some of the disclosed embodiments.

At 910, when the communication device 120 receives the key-delivery message 530, the communication device 120 reads the common header (HDR) payload 610, which provides the communication device with information needed to determine how to parse and process the key-delivery message 530. Based on the message type of the common header 610, the communication device 120 knows how to process the key-delivery message 530. Alternately, communication device 120 could parse the key-delivery message 530 and discover the signature payload (i.e., the source authentication payload 695) and then know how to process the message.

At 920, the communication device 120 applies a one-way cryptographic hash function to all other portions 610-690 of the key-delivery message 530 except for the source authentication payload 695 to generate a result.

At 930, based on the result, the public key 160 and the digital signature in the source authentication payload 695, the communication device 120 determines whether the digital signature in the source authentication payload 695 is valid.

When the digital signature has been verified to be valid, method 900 proceeds to 940, where the communication device 120 determines that the key-delivery message 530 originated from the key-management server 110. Although not illustrated, the communication device 120 can then use the pre-shared group key 130 to derive a decryption key that corresponds to the encryption key that was used to encrypt the TEK or TGK of the encrypted key data sub-payload 680, and then use the decryption key to decrypt the TEK or TGK.

When the digital signature in the source authentication payload 695 is checked and determined to be invalid, method 900 proceeds to 950, where the communication device 120 determines that it cannot confirm that the MIKEY key-delivery message 530 originated from the key-management server 110. The communication device 120 can then discard the key-delivery message.

Source Authentication Using Hash-Chain Method

In accordance with some of the other disclosed embodiments, hash-chains can be used to achieve source authentication, herein referred to as the “hash-chain method.” The hash-chain method can be useful in some implementations, for example, if public-key operations are computationally or communicatively prohibitive (e.g., in terms of CPU cycles or bytes sent over the air) for a given system.

In the hash-chain method, a hash-chain element in the source authentication payload 695 is used to protect the key-delivery message 530.

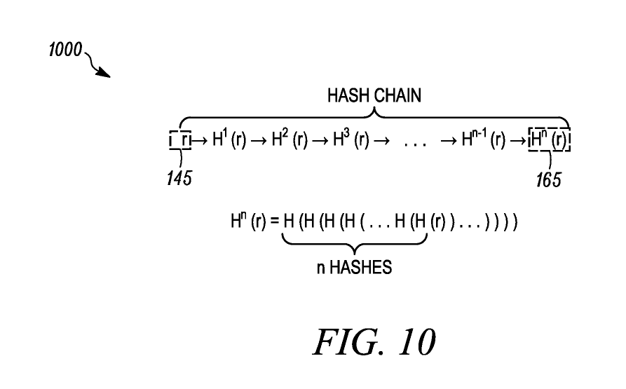

The general process of creating a hash chain with hash-chain elements is known in the art. However, the method by which they are used in this embodiment has its own intricacies and will therefore be described with reference to FIG. 10.

Referring again to FIG. 5, at 540, the communication device 120 verifies the source authentication payload 695 by hashing the hash-chain element (contained in the source authentication payload 695) to verify its “correctness” by checking to see if it equals the previously delivered hash-chain element (or last hash-chain element 165, in the case of the first message). In summary, the communication device 120 verifies that the hash-chain element in the source authentication payload 695 of the key-delivery message 530 is a valid element on the hash-chain belonging to the key-management server thereby authenticating at the communication device 120 that the key-delivery message 530 was transmitted by the key-management server 110. A valid element on the hash-chain is an element that has not been previously sent, and therefore, due to the one-way property of the hash chain, could not have been generated by any entity other than key-management server 110.

After verifying the hash-chain element carried in the source authentication payload 695 and the MAC, the communication device 120 then generates and transmits an acknowledgement message 550 back to the key-management server 110. The acknowledgement message 550 transmitted by a communication device 120 in accordance with the hash-chain method is like the acknowledgement message 550 of FIG. 7, however, to augment the security of the hash chain approach, the MAC in the verification payload (V_PAYLOAD) 740 of the acknowledgement message 550 can be constructed to cover portions of the received the key-delivery message 530 (in addition to covering the other payloads of the acknowledgement message 550). This augmentation of the verification payload (V_PAYLOAD) prevents an adversary from undetectably modifying the key-delivery message 530 because the MAC of the verification payload (V_PAYLOAD) 740 of the acknowledgement message 550 from the communication device 120 will enable the key-management server 110 to verify the integrity of the key-delivery message 530 that was received by the communication device 120. If this MAC does not verify correctly, then the key-management server 110 will suspect that the correct key-delivery message 530 was not received by communication device 120 and can take appropriate actions (e.g., resend the message, exclude communication device 120 from the group, etc.).

Aside from this additional method to protect acknowledgements, another precaution that could be taken with the hash-chain approach is to have the new keys linked to old keys using a hash chain. That is, the new key being delivered in the KEMAC payload 670 would be a pre-image of the old key (e.g., hash(new key)=old key). With this precaution, a rogue group member could not successfully send a message to replace a legitimate key with an alternate in an attempt to disrupt communications or use a key of his choosing (e.g., a weak key or one that he knows). The recipient would detect that the hash of this new key does not equal the old key and would reject it.

A final possible precaution that can be taken includes loose time synchronization (such as is required with TESLA—see RFC 4082). With loose time synchronization, the hash-chain element in the key-management message would be released according to a strict time schedule. Loose time synchronization means that messages delayed by an adversary would contain “old” elements that could be detected as being old and thereby rejected.

Thus, to summarize, in the hash-chain method the security of the source authentication payload 695 is based on an element of a hash chain that is generated by the key-management server 110 and then sent to the communication device 120 in the source authentication payload 695 of the key-delivery message 530.

FIG. 10 is diagram that illustrates an example of a hash chain and its elements that can be used in accordance with the hash-chain method. In accordance with the disclosed embodiment, the key-management server 110 can generate a hash chain 1000 (of FIG. 10) by choosing a random value (r) (i.e., a hash-chain root element 145) and then successively hashing it to create a hash chain, where Hⁿ(r) is a hash-chain last element 165, and where n is the number of times the random value (r) gets hashed. Each element (H¹(r) . . . Hⁿ(r)) in the hash-chain is created by applying the same hash function (or “hashing”) the prior hash-chain element to generate the next hash-chain element of the hash-chain. For example, hash-chain element H³(r) is generated by applying the same hash function to hash-chain element H²(r), hash-chain element H²(r) is generated by applying the same hash function to hash-chain element H¹(r), etc. The hash function is a “one-way” function so if a communication device 120 has the random value (r), the communication device 120 can compute Hⁿ(r), but if the communication device 120 has Hⁿ(r), the communication device 120 cannot compute the random value (r).

In the case of the hash-chain method, the source authentication generation data 170 will comprise a hash-chain root element 145 known by the key-management server 110 and the source authentication verification data 180 will comprise a hash-chain last element 165 known by the communication device 120.

In the hash-chain method, successive elements of the hash-chain, starting with Hⁿ⁻¹(r) and moving towards r, would be included in the source authentication payload 695 of the key-management server's key-delivery messages 530. Each time the key-management server 110 generates a transmission for one or more communication devices 120, it can include one (or more) element(s) of the hash-chain 1000 (of FIG. 10) in the source authentication payload 695 of the key-delivery message 530 for that transmission. The source authentication payload 695 includes one hash-chain element taken from the hash-chain such that the first hash-chain element is Hⁿ⁻¹(r), the next hash-chain element is Hⁿ⁻²(r), and so on until the last hash-chain element is sent (i.e., r). Given the release of hash chain elements Hⁿ(r), Hⁿ⁻¹(r), . . . , through H^{n-k}(r), only the key-management server 110 knows the next hash-chain element H^{n-k-1}(r). When a particular communication device 120 receives the next hash-chain element (i.e., H^{n-k-1}(r)), the particular communication device 120 can hash the next hash-chain element (i.e., H^{n-k-1}(r)) one time to see if it matches the previously received hash-chain element H^{n-k}(r), and if so, the particular communication device 120 knows that the key-management server 110 was the source of a particular MIKEY key-delivery message 530 since key-management server 110 was the only entity that could have possible generated the next hash-chain element (i.e., H^{n-k-1}(r)) due to the fact that the hash function is a “one-way” function. As such, the hash-chain element in the source authentication payload 695 serves as a token whose presence (and correctness) provides limited proof that the MIKEY key-delivery message 530 originated from the key-management server 110.

The key-management server 110 has to use a new hash-chain element (e.g., H^{n-k-2}(r)) for each MIKEY key-delivery message 1630 that it transmits. As such, the hash chain will eventually be depleted after element r of the hash chain is used, and a new hash-chain must be constructed and used.

Verification Message Steps

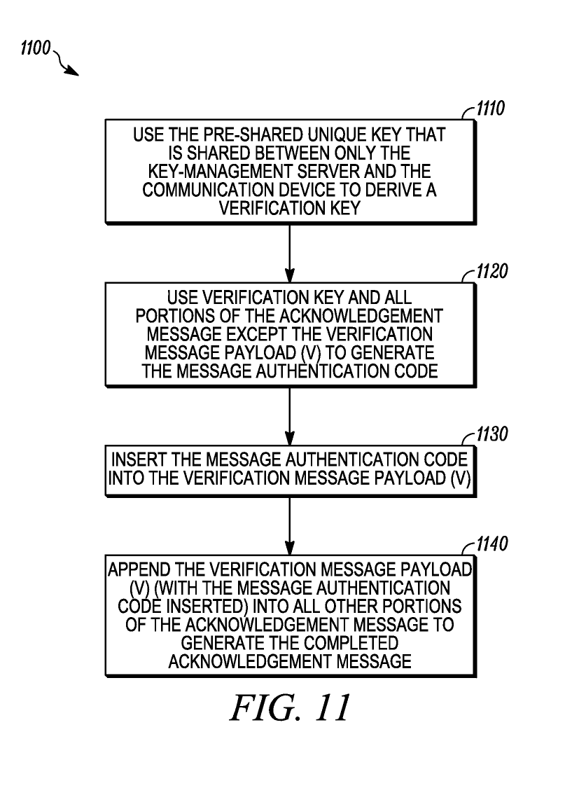

A method for generating verification message payload 740 (V_PAYLOAD) and appending it to the acknowledgement message 550 in accordance with these disclosed embodiments will be described below with reference to FIG. 11.

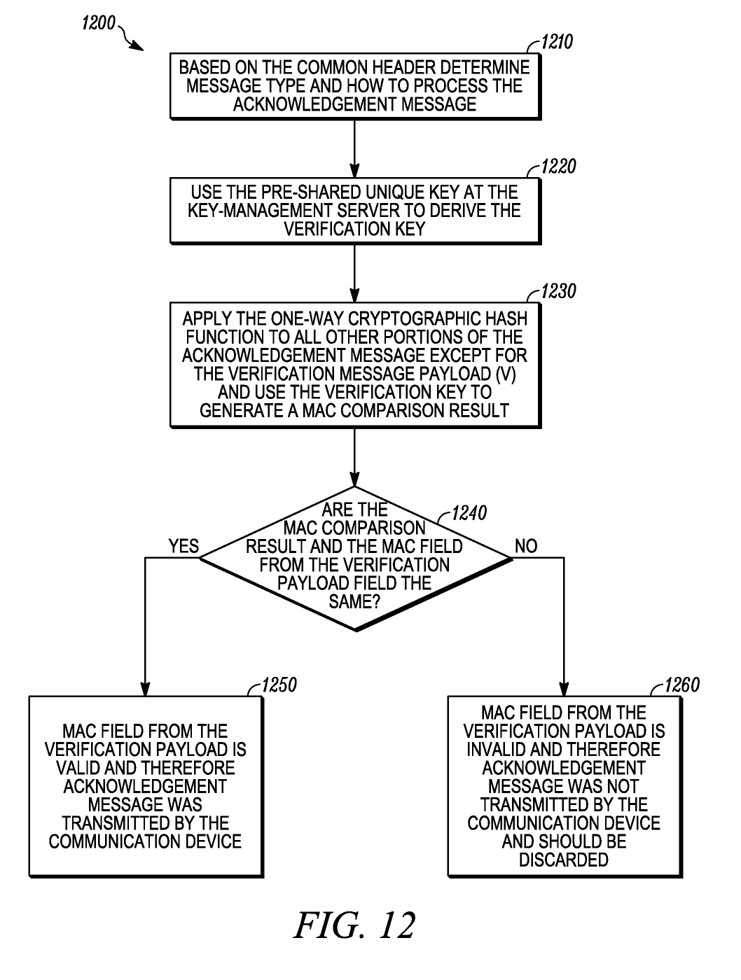

As illustrated in FIG. 5, the communication device 120 transmits the acknowledgement message 550 to the key-management server 110, and when acknowledgement message 550 is received at the key-management server 110, at 560, the key-management server 110 uses the pre-shared unique key 150 to authenticate the acknowledgement message 550. One method for processing the verification message payload 740 (V_PAYLOAD) using the pre-shared unique key 150 at the key-management server 110 to authenticate the acknowledgement message 550 in accordance with some of the disclosed embodiments, will be described below with reference to FIG. 12. When the key-management server 110 determines that the verification message payload 740 is valid, this authenticates that the acknowledgement message 550 was transmitted by the communication device 120. When the key-management server 110 determines that the verification message payload 740 is invalid the key-management server 110 cannot determine that the acknowledgement message 550 was transmitted by the communication device 120 and can discard it.

Thus, in accordance with protocol 500, security of the transmitted messages is based on two keys and a source authentication secret: the pre-shared unique key 150 (e.g., the MUK in one implementation), the pre-shared group key 130 (e.g., MSK in one implementation) and the source authentication secret 170. The pre-shared unique key 150 provides for source authentication of the acknowledgement message 550, the pre-shared group key 130 protects the encrypted data in KEMAC 670 against eavesdropping, and source authentication secret 170 is used to generate the source authentication payload 695, which provides for source authentication of the key-delivery message 530.

FIG. 11 illustrates a method 1100 for generating verification message payload 740 and appending it to the acknowledgement message 550 in accordance with some of the disclosed embodiments. At 1110, the communication device 120 uses the pre-shared unique key 150 that is shared between only the key-management server 110 and the communication device 120 to derive a verification key (e.g., authentication key). At 1120, the communication device 120 uses the verification key and all other portions 710-730 of the acknowledgement message 550 except for the verification message payload (V_PAYLOAD) 740 to generate the Message Authentication Code of the verification message payload (V_PAYLOAD) 740. At 1130, the communication device 120 inserts the Message Authentication Code into the verification message payload (V_PAYLOAD) 740, and at 1140, appends the verification message payload (V_PAYLOAD) 740 having the Message Authentication Code therein to the all other portions of the acknowledgement message 550. In an alternate embodiment, the Message Authentication Code of the verification message payload (V_PAYLOAD) 740 calculated at step 1120 covers not just portions 710-730 of the acknowledgement message 550, but additionally covers portions (or all) of the key-delivery message 530. Covering key-delivery message 530 with the Message Authentication Code of the verification message payload (V_PAYLOAD) 740 provides additional assurance to key-management server 110 that communication device 120 received the intended, correct (unaltered) key-delivery message 530. This additional assurance is especially important when using the hash-chain method for source authentication because unlike the signature method, the hash chain element does not protect the integrity of the entire key-delivery message 530. Hence, by covering the key-delivery message 530 with a Message Authentication Code contained in the acknowledgement message 550, the key-management server 110 can determine whether the key-delivery message 530 received by communication device 120 was modified.

As illustrated in FIG. 5, the communication device 120 transmits the acknowledgement message 550 to the key-management server 110, and when it is received at the key-management server 110 at 560, the key-management server 110 uses the pre-shared unique key 150 to thereby authenticate the acknowledgement message 550. FIG. 12 illustrates a method 1200 for processing the verification message payload (V_PAYLOAD) 740 using the pre-shared unique key 150 at the key-management server 110 to authenticate the acknowledgement message 550 in accordance with some of the disclosed embodiments.

At 1210, the key-management server 110 determines, based on a common header 710 of the acknowledgement message 550, a message type and how to process the acknowledgement message 550.

At 1220, the key-management server 110 uses the pre-shared unique key 150 at the key-management server 110 to derive the verification key.

At 1230, the key-management server 110 applies the one-way cryptographic hash function to the verification key and to the all other portions 710-730 of the acknowledgement message 550 except the verification message payload (V_PAYLOAD) 940 to generate a Message Authentication Code comparison result. Alternatively, key-management server 110 additionally applies the one-way cryptographic hash function to the key-delivery message 530 (or portions thereof) to generate the Message Authentication Code comparison result.

At 1240, the key-management server 110 compares the Message Authentication Code comparison result to the Message Authentication Code of the verification message payload (V_PAYLOAD) 740.

When the Message Authentication Code comparison result and the Message Authentication Code of the verification message payload (V_PAYLOAD) 940 are the same, at 1250, the key-management server 110 determines that the Message Authentication Code of the verification message payload (V_PAYLOAD) 740 has been verified as valid and thereby authenticates that the acknowledgement message 550 was transmitted by the communication device 120.

When the Message Authentication Code comparison result and the Message Authentication Code of the verification message payload (V_PAYLOAD) 740 are different, at 1260, the key-management server 110 determines that the Message Authentication Code of the verification message payload (V_PAYLOAD) 740 has not been verified and is invalid and thereby cannot determine that the acknowledgement message 550 was transmitted by the communication device 120, and can discard it.

Delivery of Source Authentication Verification Data

In protocol 500, the communication device 120 needs to know the source authentication verification data 180 which is used for verifying the source authentication payload 695 at 540. There are different methods that can be used to deliver this source authentication verification data 180 to the communication device 120.

One such method would be to deliver the source authentication verification data 180 of the key-management server 110 to the communication device 120 out-of-band. In this context, out-of-band includes any delivery means other than with the MIKEY message itself. For example, the device could be pre-loaded with a public key 160 or a hash-chain last element 165. A special device could be used to convey the source authentication verification data 180 (e.g., a key loader device could connect to the device and inject it with the public key 160). This method would save bandwidth since the source authentication verification data 180 would not need to be communicated every time (and would keep the key-management server 110 and the communication device 120 implementations simpler).

Another such method would be to deliver the source authentication verification data 180 of the key-management server 110 to the communication device 120 in-band. In this context, in-band includes using the MIKEY message itself to deliver the source authentication verification data 180. In particular, either a new payload or the optional KMS ID payload 640 in key-delivery message 530 can be used to convey the source authentication verification data 180 from key-management server 110 to communication device 120.

In various embodiments, source authentication verification data 180, delivered via an initial key-delivery message 530, may be a public key 160, an unsigned or signed certificate containing a public key 160, or a signed or unsigned a hash-chain last element 165. Source authentication verification data 180 can be signed by a third party trusted by communication device 120. For example, a certificate containing a public key 160 may be signed by a trusted certificate authority or a certificate containing a public key 160 may be signed by an entity whose public key is then signed by a trusted certificate authority, and so on (i.e., a certificate chain). In one embodiment, one initial instance of protocol 500 can be used for delivery of source authentication verification data 180 and other instances of protocol 500 can be used to deliver group keys (e.g., TEKs or TGKs). In another embodiment, one initial instance of protocol 500 can be used for both delivery of source authentication verification data 180 and a group key (e.g., a TEK or TGK) and other instances of protocol 500 can be used to just deliver group keys (e.g., a TEKs or TGKs).

Delivery of Certificate(s) not Anchored by a Trusted Authority

In one embodiment, the main objective of the key-delivery message 530 is to transport one or more self-signed or unsigned certificates containing public key 160. These certificate(s) would be carried in a new payload, the optional KMS ID payload 640), or the certificate payload already described in the MIKEY specification (RFC 3830) for use with the public-key and Diffie-Hellman modes. In one implementation, the data type for the new payload containing the certificate(s) has a value in the range of 26-240 that is not defined in any of the prior MIKEY standards. Key-delivery message 530 includes one or more self-signed or unsigned certificates that contain a public key 160 of the key-management server 110. Each self-signed or unsigned certificate is used to deliver a public key 160 (that is used to verify the source authentication payload 695 at 540). In one approach, the key-management server ID [IDi] payload 340 of FIG. 3 is replaced with a certificate payload that includes a certificate that is either unsigned or self-signed (i.e., signed by the key-management server 110). In this sense, this is a hybrid pre-shared key MIKEY mode and public key MIKEY mode in that the public-key mode already offers the option of using a certificate or an ID. However, pre-shared key mode does not have this option because only an ID is described). Including a certificate in this hybrid mode allows the key-delivery message 530 to transport the public key 160 that is used by the communication device 120 to verify the source authentication payload 695 in subsequent key-delivery messages 530. In addition, the encrypted key data sub-payload 680 in the key-delivery message 530 is optional and need not be sent in some implementations. In other words, the encrypted key data sub-payload 680 may not include any data (e.g., the size of can be zero bytes in length) when used in key-delivery message 530 of FIG. 6, since a TGK or TEK need not be delivered when key-delivery message 530 is used to deliver the public key 160.

When key-delivery message 530 is to transport one or more self-signed or unsigned certificates containing public key 160, the MAC data for the MAC data sub-payload 690 is generated using a key derived from the pre-shared unique key 150 (e.g., MUK in one implementation). In one implementation, this MAC data for the MAC data sub-payload 690 is generated by using a key derived from the pre-shared unique key 150 (e.g., MUK) as input to a MAC algorithm 685 (e.g., a cryptographic hash function) that is applied over fields 610-685 (i.e., the entire message 530 except MAC data 690). As described above, the pre-shared unique key 150 is shared between the key-management server 110 and the communication device 120 and only the communication device 120 and the key-management server 110 possess it. Hence, if communication device 120 receives a key-delivery message 530 (containing a public key 160) that has a valid MAC data sub-payload 690, then communication device 120 can be assured that only key-management server 110 could have sent key-delivery message 530, so it can trust that the public key 160 in this message contains is the correct public key 160 to be used for verifying subsequent MIKEY messages that the key-management server 110 signed with the corresponding private key 140. In this case, the source authentication payload 695 is not needed in key-delivery message 530 because source authentication is achieved via use of the pre-shared unique key 150.

Delivery of Certificate(s) Anchored by a Trusted Authority

In one embodiment, the main objective of the key-delivery message 530 is to transport a trusted-third-party-signed certificate containing public key 160, where the certificate containing public key 160 may be signed by a trusted certificate authority. Alternately, the certificate containing public key 160 may be signed by an entity whose public key is then signed by a trusted certificate authority, and so on (i.e., a certificate chain). As in the previous description, these certificate(s) would be part of an initial key-delivery message 530 and would be carried in a new payload, the optional KMS ID payload 640), or the certificate payload already described in the MIKEY specification (RFC 3830) for use with the public-key and Diffie-Hellman modes.

When key-delivery message 530 is to transport a trusted-third-party-signed certificate(s) containing public key 160, the MAC data for the MAC data sub-payload 690 can be generated using a key derived from the pre-shared group key 130 (e.g., MSK in one implementation) rather than a pre-shared unique key 150. In this case, the source authentication payload 695 is needed in key-delivery message 530 because source authentication is not achieved via use of the pre-shared group key 130.

Delivery of Hash-Chain Last Element

In one embodiment, the main objective of the key-delivery message 530 is to transport hash-chain last element 165 to communication device 120. The key-management server 110 can use an initial key-delivery message 530 to securely convey (e.g., unicast under the protection a pre-shared unique key 160) the hash-chain last element 165 Hⁿ(r) to all communication devices 120 so that each communication device 120 has the hash-chain last element Hⁿ(r). In other words, the last element Hⁿ(r) of the hash-chain is the first element of the hash-chain that is securely delivered to each communication device 120 in the group (e.g., via a unicast message secured with an MUK). For example, the hash-chain last element 165 could be delivered as if it were a public key using either of the previously described approaches for delivery of a public key in either a signed or unsigned certificate.

Conclusion

As described above, the standard MIKEY pre-shared key protocol can be inadequate in some cases since, for example, a rogue group member can potentially deliver spoofed key-management messages to victim communication devices 120. To address this issue, various embodiments of source authentication techniques have been described that can prevent a rogue group member from delivering spoofed key-management messages to communication devices 120.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
generating at a key-management server a key-delivery message comprising: a key data transport payload secured with a group key, and a source authentication payload;
transmitting, by the key-management server, the key-delivery message;
receiving the key-delivery message at a communication device; and
verifying at the communication device that the source authentication payload of the key-delivery message is valid thereby authenticating at the communication device that the key-delivery message was transmitted by the key-management server.

2. A method according to claim 1, wherein the source authentication payload comprises: a signature payload representing a digital signature of the key-delivery message generated using a private key of the key-management server, and wherein verifying at the communication device that the source authentication payload of the key-delivery message is valid, comprises:
using a public key at the communication device to verify the digital signature of the key-delivery message in the signature payload and thereby authenticating at the communication device that the key-delivery message was transmitted by the key-management server.

3. A method according to claim 2, wherein the key-delivery message further comprises:
a digital certificate chain comprising one or more digital certificates whereby a root of the digital certificate chain is signed by a third-party that is trusted by the communication device, the digital certificate chain containing the public key that is used to verify the digital signature payload.

4. A method according to claim 1, wherein the source authentication payload comprises: a hash-chain element generated using a hash-chain belonging to the key-management server, and wherein verifying at the communication device that the source authentication payload of the key-delivery message is valid, comprises:
verifying, at the communication device, that the hash-chain element in the source authentication payload of the key-delivery message is a valid element on the hash-chain belonging to the key-management server thereby authenticating at the communication device that the key-delivery message was transmitted by the key-management server.

5. A method according to claim 1, wherein the key-delivery message further comprises:
a modified common header having a message type that indicates that the key-delivery message is to be processed per a modified Multimedia Internet KEYing (MIKEY) protocol.

6. A method according to claim 1, wherein the key data transport payload comprises:
a payload comprising a key that is encrypted with an encryption key derived from the group key.

7. A method according to claim 6, wherein the key data transport payload further comprises:
a message authentication code sub-payload comprising a message authentication over the key data transport payload secured with an authentication key derived from the group key.

8. A method according to claim 1, when the source authentication payload has been verified, further comprising:
generating, at the communication device, an acknowledgement message comprising:
a verification payload containing a Message Authentication Code over the acknowledgment message secured with a pre-shared unique key that is shared between only the key-management server and the communication device; and
transmitting the acknowledgement message from the communication device to the key-management server.

9. A method according to claim 8, wherein the pre-shared unique key is a Multimedia Broadcast/Multicast Service (MBMS) User Key (MUK) that only the key-management server and the communication device possess.

10. A method according to claim 8, after transmitting the acknowledgement message from the communication device to the key-management server, further comprising:
receiving the acknowledgement message at the key-management server; and
using the pre-shared unique key at the key-management server to verify the acknowledgement message thereby authenticating at the key-management server that the key-delivery message was transmitted by the communication device.

11. A method according to claim 1, wherein the group key is a key that is shared between the key-management server and all the communication devices in a group.

12. A method according to claim 1, wherein the group key is a Multimedia Broadcast/Multicast Service (MBMS) Service Key (MSK) that is shared by the key-management server and a group of communication devices.

13. A method according to claim 1, wherein the key-delivery message is a key-management message transmitted to the communication device as part of a modified Multimedia Internet KEYing (MIKEY) protocol.

14. A method according to claim 1, the method further comprising:
generating an initial key-delivery message at the key-management server, the initial key-delivery message comprising: source authentication verification data that is used by the communication device to verify the source authentication payload; and
transmitting the initial key-delivery message to the communication device before transmitting the key-delivery message.

15. A key-management server, comprising:
a processor designed to generate a key-delivery message comprising: a key data transport payload secured with a group key, and a source authentication payload generated by the key-management server, wherein the source authentication payload of the key-delivery message is designed to be verified at a communication device to thereby authenticate that the key-delivery message was transmitted by the key-management server; and
a transmitter designed to transmit the key-delivery message.

16. A key-management server according to claim 15, wherein the source authentication payload comprises:
a signature payload representing a digital signature of the key-delivery message generated using a private key of the key-management server, and wherein the digital signature of the key-delivery message in the signature payload is designed to be verified at the communication device using a public key thereby authenticating at the communication device that the key-delivery message was transmitted by the key-management server.

17. A key-management server according to claim 15, wherein the key-delivery message further comprises:
source authentication data that is used to verify the source authentication payload.

18. A key-management server according to claim 15, wherein the source authentication payload comprises:
a hash-chain element generated using a hash-chain belonging to the key-management server, and wherein the hash-chain element in the source authentication payload of the key-delivery message is designed to be verified at the communication device as a valid element on the hash-chain belonging to the key-management server thereby authenticating at the communication device that the key-delivery message was transmitted by the key-management server.

19. A key-management server according to claim 15, wherein the key-delivery message further comprises:
a modified common header having a message type that indicates that the key-delivery message is to be processed per a modified Multimedia Internet KEYing (MIKEY) protocol.

20. A key-management server according to claim 19, wherein the key data transport payload comprises:
a payload comprising a key that is encrypted with an encryption key derived from the group key.

21. A key-management server according to claim 20, wherein the key data transport payload further comprises:
a message authentication code sub-payload comprising a message authentication over the key data transport payload secured with an authentication key derived from the group key.

22. A key-management server according to claim 15, further comprising:
a receiver that is designed to receive an acknowledgement message from the communication device, comprising: a verification payload containing a Message Authentication Code over the acknowledgment message secured with a pre-shared unique key that is shared between only the key-management server and the communication device, and wherein the processor is further designed to use the pre-shared unique key to verify the acknowledgement message thereby authenticating that the key-delivery message was transmitted by the communication device.

23. A communication device, comprising:
a receiver designed to receive a key-delivery message from a key-management server, the key-delivery message comprising a key data transport payload secured with a group key that is shared with a key-management server, and a source authentication payload ; and
a processor designed to verify the source authentication payload of the key-delivery message thereby authenticating that the key-delivery message was transmitted by the key-management server.

24. A communication device according to claim 23, wherein the source authentication payload comprises:
a signature payload representing a digital signature of the key-delivery message generated using a private key of the key-management server, and
wherein the processor is further designed to use a public key to verify the digital signature of the key-delivery message in the signature payload thereby authenticating that a key-delivery message was transmitted by the key-management server

25. A communication device according to claim 23, wherein the key-delivery message further comprises:
source authentication data that is used to verify the source authentication payload.

26. A communication device according to claim 23, wherein the source authentication payload comprises:
a hash-chain element generated using a hash-chain belonging to the key-management server, and
wherein the processor is further designed to:
verify that the hash-chain element in the source authentication payload of the key-delivery message is a valid element on the hash-chain belonging to the key-management server thereby authenticating that the key-delivery message was transmitted by the key-management server.

27. A communication device according to claim 23, wherein the key-delivery message further comprises:
a modified common header having a message type that indicates that the key-delivery message is to be processed per a modified Multimedia Internet KEYing (MIKEY) protocol, and
wherein the processor of the communication device is further configured to:
determine, based on the common header payload, the message type and how to process the key-delivery message.

28. A communication device according to claim 27, wherein the key data transport payload comprises:
a payload comprising a key that is encrypted with an encryption key derived from the group key.

29. A communication device according to claim 28, wherein the key data transport payload further comprises:
a message authentication code sub-payload comprising a message authentication over the key data transport payload secured with an authentication key derived from the group key.

30. A communication device according to claim 23, when the source authentication payload has been verified, wherein the processor of the communication device is further configured to:
generate an acknowledgement message for the key-management server, the acknowledgement message comprising a verification payload containing a Message Authentication Code over the acknowledgment message secured with a pre-shared unique key that is shared between only the key-management server and the communication device, wherein the acknowledgement message is designed to be verified at the key-management server using the pre-shared unique key and thereby authenticate that the key-delivery message was transmitted by the communication device.

31. A communication device according to claim 23, wherein the key-delivery message is a key-management message transmitted to the communication device as part of a modified Multimedia Internet KEYing (MIKEY) protocol.
